(19) United States
(12) Patent Application Publication
(10) Pub. No.: US 2023/0192111 A1
(43) Pub. Date: Jun. 22, 2023

(54) INPUT PROCESSING DEVICE, FUNCTION SETTING METHOD, STORAGE MEDIUM

(71) Applicant: TOYOTA JIDOSHA KABUSHIKI KAISHA, Toyota-shi Aichi-ken (JP)

(72) Inventor: Atsuko YAMADA, Okazaki-shi Aichi-ken (JP)

(73) Assignee: TOYOTA JIDOSHA KABUSHIKI KAISHA, Toyota-shi Aichi-ken (JP)

(21) Appl. No.: 17/985,185

(22) Filed: Nov. 11, 2022

(30) Foreign Application Priority Data
Dec. 20, 2021 (JP) 2021-205767

(51) Int. Cl. B60W 50/08; G06F 3/01; B60W 60/00

(52) U.S. Cl. CPC B60W 50/082; G06F 3/013; G06F 3/012; B60W 60/0051; B60W 2540/215; B60W 2540/225; B62D 1/046

(57) ABSTRACT

An input processing device according to the present disclosure is configured to execute: a process for detecting a first specific state indicating that a direction of eyes or a face of a driver of a vehicle is facing a direction of a switch mounted on the vehicle; a process for acquiring a depression state of the switch; and a process for controlling, when the switch is depressed, an operation state of a specific function based on the depression state in a case where the first specific state is detected between a time when the switch is depressed and a first predetermined time before the time when the switch is depressed.

### CROSS-REFERENCE TO RELATED APPLICATION

This application claims priority to Japanese Patent Application No. 2021-205767 filed on Dec. 20, 2021, incorporated herein by reference in its entirety.

### BACKGROUND

### 1. Technical Field

The present disclosure relates to a technique for providing operation according to a state of a driver of a vehicle. In particular, the present disclosure relates to a technique for setting an operation state of a specific function by a switch mounted on the vehicle.

### 2. Description of Related Art

Japanese Unexamined Patent Application Publication No. 2020-057441 (JP 2020-057441 A) discloses an operation device including an operation unit having an operation region corresponding to each of the plurality of operation targets to be output, a line of sight detection unit that detects the line of sight of an operator, and a control unit that estimates an operation target the operator's line of sight has faced for a predetermined time or more, among the plurality of operation targets, as an operation candidate and that changes the area of the operation region of the operation unit corresponding to the operation candidate from the initial setting.

WO 14/016911 discloses a driving support device that restricts a driver's driving operation when a misoperation determination unit determines that the driver's driving operation is a misoperation, during the time from when a driver state detection unit receives a control start signal to when a consent confirmation unit receives an answer of permission for control execution.

### SUMMARY

Some of the functions implemented in the vehicle are configured so that the operation state can be set by a switch mounted on the vehicle. Thus, the driver can perform setting in accordance with the driving environment and his/her own preferences. In particular, with regard to the driving support function and the autonomous driving function of the vehicle, it is assumed that the driver wants to switch the operation state of the functions relatively frequently. Therefore, switches for these functions may be arranged in positions that are easy for a driver to operate with the intention of improving operability.

On the other hand, if the switches are arranged in positions that are easy to operate, there is a risk that the driver will unintentionally switch the operation state of the functions due to a misoperation. In particular, unintentionally switching the operation state of the driving support function and the autonomous driving function of the vehicle is an issue in ensuring the safety of the vehicle.

An object of the present disclosure is to provide a technique capable of reducing the possibility that a driver unintentionally switches the operation state of a function due to a misoperation.

A first disclosure relates to an input processing device. The input processing device according to the first disclosure is configured to execute: a process for detecting a first specific state indicating that a direction of eyes or a face of a driver of a vehicle is facing a direction of a switch mounted on the vehicle; a process for acquiring a depression state of the switch; and a process for controlling, when the switch is depressed, an operation state of a specific function based on the depression state in a case where the first specific state is detected between a time when the switch is depressed and a first predetermined time before the time when the switch is depressed.

A second disclosure relates to an input processing device further having the following characteristics with respect to the input processing device according to the first disclosure. The input processing device according to the second disclosure is configured to further execute: a process for detecting a second specific state indicating that a finger of the driver is in contact with a pressing surface of the switch; and a process for controlling, when the switch is depressed, the operation state of the specific function based on the depression state in a case where the first specific state is detected between a time when the second specific state is detected and a second predetermined time before the time when the second specific state is detected, and the second specific state is continuously detected until the time when the switch is depressed.

A third disclosure relates to an input processing device further having the following characteristics with respect to the input processing device according to the first or second disclosure. The specific function is a driving support function or an autonomous driving function of the vehicle.

A fourth disclosure relates to an input processing device further having the following characteristics with respect to the input processing device according to any one of the first to third disclosures. The switch is mounted on a steering wheel of the vehicle.

A fifth disclosure relates to a function setting method for setting an operation state of a specific function by a switch mounted on a vehicle. The function setting method according to the fifth disclosure includes: detecting a first specific state indicating that a direction of eyes or a face of a driver of the vehicle is facing a direction of the switch mounted on the vehicle; acquiring a depression state of the switch; and controlling, when the switch is depressed, the operation state of the specific function based on the depression state in a case where the first specific state is detected between a time when the switch is depressed and a first predetermined time before the time when the switch is depressed.

A sixth disclosure relates to a function setting method further having the following characteristics with respect to the function setting method according to the fifth disclosure. The function setting method according to the sixth disclosure further includes: detecting a second specific state indicating that a finger of the driver is in contact with a pressing surface of the switch; and controlling, when the switch is depressed, the operation state of the specific function based on the depression state in a case where the first specific state is detected between a time when the second specific state is detected and a second predetermined time before the time when the second specific state is detected, and the second specific state is continuously detected until the time when the switch is depressed.

A seventh disclosure relates to a storage medium storing a control program executed by a computer and causing the computer to execute the function setting method related to the fifth or sixth disclosure.

According to the present disclosure, when the switch is depressed, the control of the operation state of a specific function based on the depression state is performed in the case where the first specific state is detected between the time when the switch is depressed and the first predetermined time before the time when the switch is depressed. In this way, it can be determined that the driver reliably recognizes and operates the switch for a specific function. Furthermore, the possibility that the driver unintentionally switches the operation state of a specific function due to a misoperation can be reduced.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a conceptual diagram showing an example of an environment around a driver's seat of a vehicle when an input processing device according to the present embodiment is applied;

FIG. 2 is one of conceptual diagrams illustrating a first example of on/off of a specific function by a switch realized by the input processing device according to the present embodiment;

FIG. 3 is one of the conceptual diagrams illustrating the first example of on/off of the specific function by the switch realized by the input processing device according to the present embodiment;

FIG. 4 is one of conceptual diagrams illustrating a second example of on/off of a specific function by the switch realized by the input processing device according to the present embodiment;

FIG. 5 is one of the conceptual diagrams illustrating the second example of on/off of the specific function by the switch realized by the input processing device according to the present embodiment;

FIG. 6 is a block diagram showing a schematic configuration of the input processing device according to the present embodiment;

FIG. 7 is a block diagram showing a configuration of processes executed by a processor in the input processing device according to the present embodiment; and

FIG. 8 is a flow chart showing the processes executed by the processor in an operation state control process shown in FIG. 7.

### DETAILED DESCRIPTION OF EMBODIMENTS

Hereinafter, an embodiment of the present disclosure will be described with reference to the drawings. However, when the number, quantity, amount, range, etc. of each element are referred to in the embodiments shown below, the idea of the present disclosure is not limited to the numbers mentioned herein except when explicitly stated or when clearly specified by the number in principle. In addition, the configurations and the like described in the embodiments shown below are not necessary to the idea of the present disclosure, except when explicitly stated or when clearly specified in principle. In each figure, the same or corresponding parts are designated by the same reference signs, and duplicated description thereof will be appropriately simplified or omitted.

1. Outline

In general, various functions are implemented in vehicles. Functions that can be implemented include a navigation function, a parking assistance function, a driving support function (for example, Adaptive Cruise Control (ACC)), a lane departure suppression support function, a collision damage reduction brake function, and traction control), an autonomous driving function, etc. Some of these functions are configured so that the operation state can be set by a switch mounted on the vehicle. For example, the ACC generally involves turning on/off functions and changing control settings (inter-vehicle distance, set vehicle speed, etc.) by a switch.

In particular, with regard to the driving support function and the autonomous driving function of the vehicle, it is assumed that the driver wants to switch the operation state of the functions relatively frequently. Therefore, switches for these functions may be arranged in positions that are easy for the driver to operate with the intention of improving operability. For example, the switch for the ACC is generally arranged on the steering wheel.

On the other hand, if the switches are arranged in positions that are easy to operate, there is a risk that the driver will unintentionally switch the operation state of the functions due to a misoperation. In particular, unintentionally switching the operation state of the driving support function and the autonomous driving function of the vehicle is an issue in ensuring the safety of the vehicle.

Therefore, the input processing device according to the present embodiment detects that the direction of the eyes or the face of the driver of the vehicle is facing the direction of the switches (hereinafter referred to as the “first specific state”). For a specific function, it is determined whether the operation state is controlled based on the depression state of the switch depending on whether the first specific state is detected between a time when the switch is depressed and a predetermined time (first predetermined time) before the time when the switch is depressed.

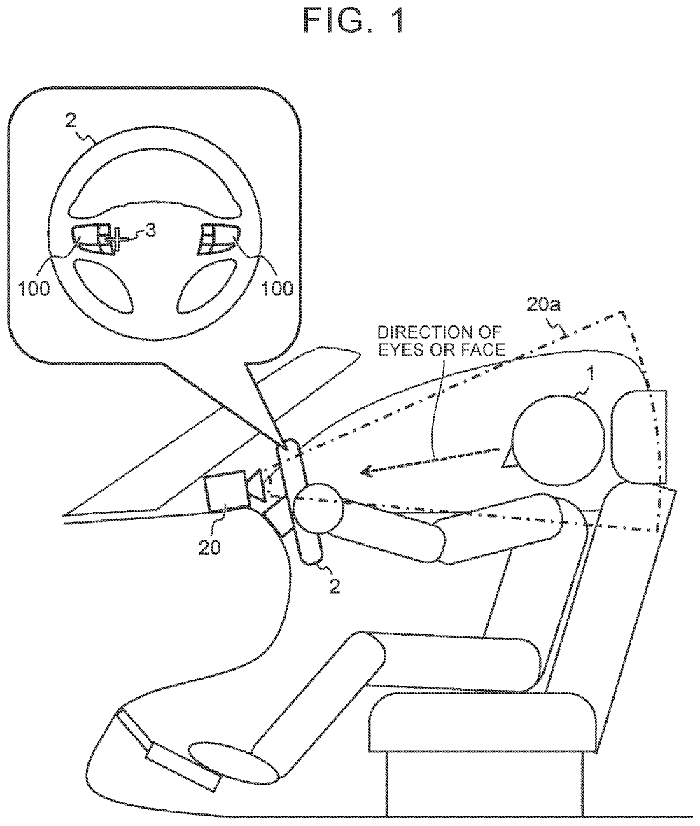

FIG. 1 shows an example of the environment around the driver's seat of the vehicle when the input processing device according to the present embodiment is applied. In FIG. 1, switches 100 are mounted on a steering wheel 2. The switches 100 include switches for setting the operation state of the driving support function and the autonomous driving function. For example, the switches 100 are a switch that turns on/off a function, a switch that changes the set vehicle speed, etc.

In FIG. 1, a driver monitor 20 is provided around the driver's seat. An imaging range 20a of the driver monitor 20 includes the head of a driver 1. The direction of the eyes or the face of the driver 1 can be acquired through image recognition of the image taken by the driver monitor 20. Alternatively, the driver monitor 20 executes image recognition processing, and the driver monitor 20 outputs information on the direction of the eyes or the face of the driver 1. The first specific state can be detected from the direction of the eyes or the face of the driver 1. For example, a position 3 indicating the projection of the direction of the eyes or the face of the driver 1 is present on the switch 100, so that the first specific state is detected.

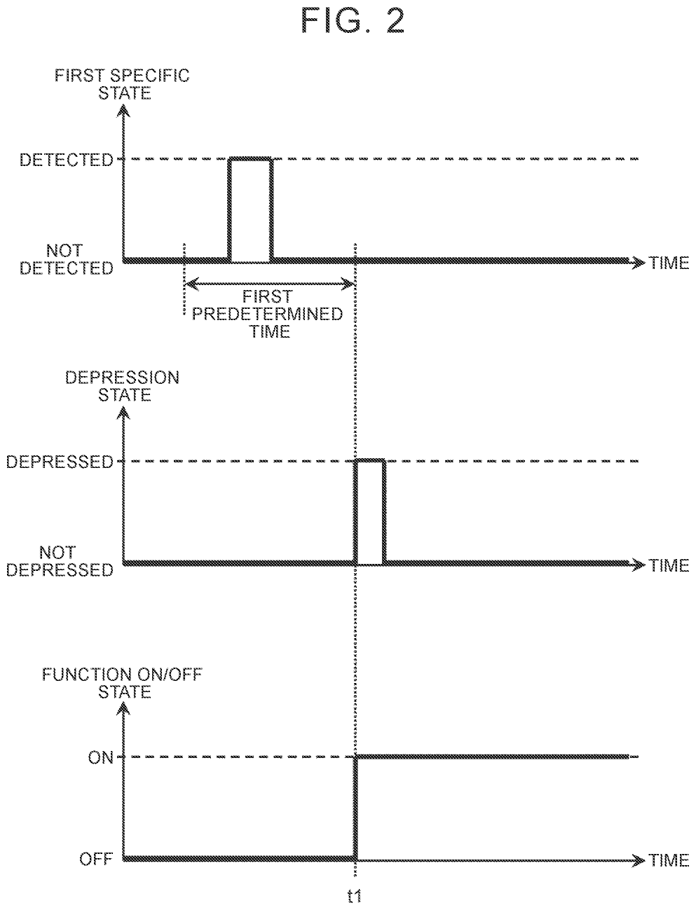

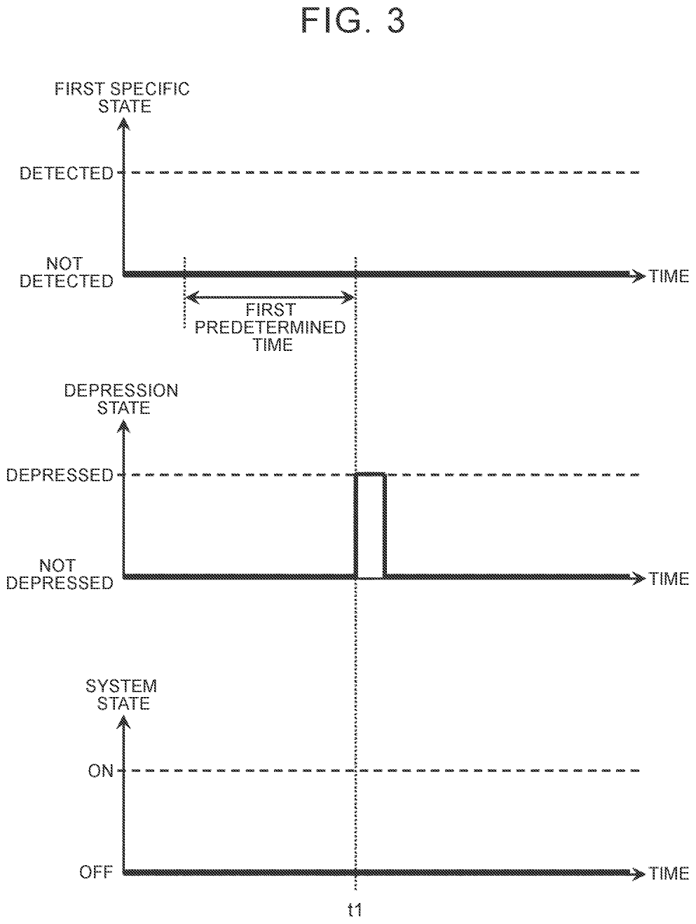

Hereinafter, referring to FIG. 2 and FIG. 3, a first example of on/off of a specific function by the switch 100 realized by the input processing device according to the present embodiment is explained. In FIG. 2 and FIG. 3, the presence or absence of detection of the first specific state and the on/off state of the function for the depression state of the switch 100 are shown on the same time axis. Here, in FIG. 2 and FIG. 3, the on/off control of a specific function based on the depression state of the switch 100 indicates the case where on/off of the function is switched when a rise during the depression of the switch 100 is detected.

First, refer to FIG. 2. In FIG. 2, the switch 100 is depressed at time t1. The first specific state is detected between time t1 and the first predetermined time before time t1. At this time, the input processing device according to the present embodiment controls on/off of the specific function based on the depression state of the switch 100, and the function is switched from off to on at time t1.

Next, refer to FIG. 3. In FIG. 3, the switch 100 is depressed at time t1 similarly to FIG. 2. However, in FIG. 3, the first specific state is not detected between time t1 and the first predetermined time before time t1. At this time, the input processing device according to the present embodiment does not control on/off of the specific function based on the depression state of the switch 100, and the function remains off.

Furthermore, the input processing device according to the present embodiment is configured to detect that the finger of the driver 1 is in contact with the pressing surface of the switch 100 (hereinafter referred to as the “second specific state”). Even when the first specific state is not detected between the time when the switch is depressed and the first predetermined time before the time when the switch is depressed, when the first specific state is detected between the time when the second specific state is detected and a predetermined time (second predetermined time) before the time when the second specific state is detected, and the second specific state is continuously detected until the time when the switch is depressed, the operation state is controlled based on the depression state of the switch.

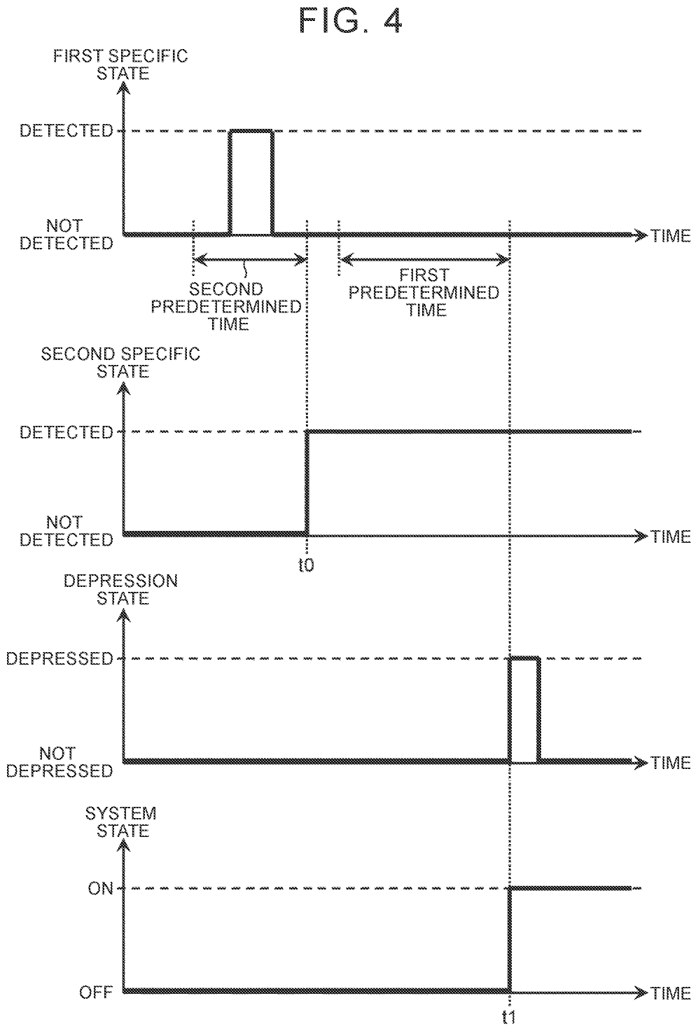

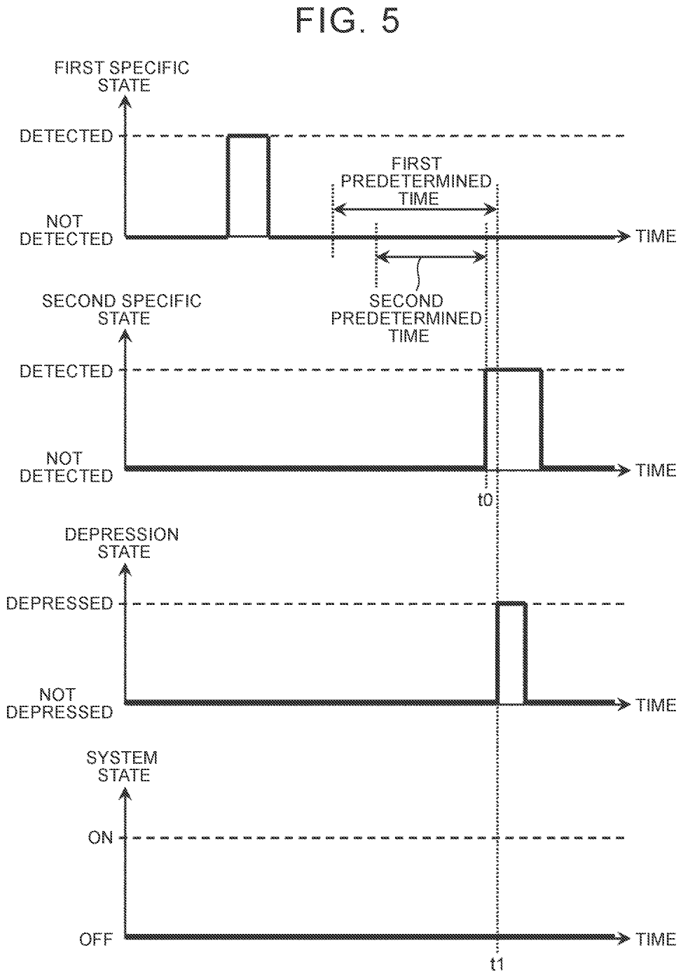

Referring to FIG. 4 and FIG. 5, a second example of on/off of the specific function by the switch 100 realized by the input processing device according to the present embodiment is explained. FIG. 4 and FIG. 5 show diagrams similar to FIG. 2 and FIG. 3.

First, refer to FIG. 4. In FIG. 4, the switch 100 is depressed at time t1. However, the first specific state is not detected between time t1 and the first predetermined time before time t1. Meanwhile, the second specific state is detected at time t0, and the first specific state is detected between time t0 and the second predetermined time before time t0. Further, the second specific state is continuously detected from time t0 to time t1. Thus, the input processing device according to the present embodiment controls on/off of the specific function based on the depression state of the switch 100, and the function is switched from off to on at time t1.

In FIG. 4, if there is a period in which the second specific state is not detected between time t0 and time t1, detection of the second specific state is not regarded as continuing, and on/off control of the specific function based on the depression state of the switch 100 is not performed.

Next, refer to FIG. 5. In FIG. 5, similarly to FIG. 4, the switch 100 is depressed at time t1 and the first specific state is not detected between time t1 and the first predetermined time before time t1. Further, the first specific state is not detected between time t0 at which the second specific state is detected and the second predetermined time before time t0. Thus, the input processing device according to the present embodiment does not control on/off of the specific function based on the depression state of the switch 100, and the function remains off.

In the above description, the case where the on/off control of the specific function based on the depression state of the switch 100 is switched when the rise during the depression of the switch 100 is detected has been described, but it is also possible to apply this to other controls. For example, this can also be applied to control for switching on/off a function when the fall during the depression of the switch 100 is detected, or control for switching on/off a function when the switch 100 that has been held down (the switch 100 that has been continuously depressed for a predetermined time or more) is detected.

Also, in the above description, on/off of the specific function based on the depression state of the switch 100 has been described, but this can also be applied to switching the operation state of other specific functions such as changing the control setting based on the depression state of the switch 100. However, the configuration may be applied only to on/off of a specific function. In this case, for example, in changing the control setting of a specific function, control is performed based on the depression state of the switch 100 regardless of the detection of the first specific state or the second specific state. Furthermore, the configuration may be applied only for turning on a specific function. In this case, when a specific function is turned off, control based on the depression state of the switch 100 is performed regardless of detection of the first specific state or the second specific state. These configurations may be suitably provided in accordance with the environment in which the input processing device according to the present embodiment is applied. Thus, a trade-off with usability can be appropriately achieved while reducing the possibility that the driver unintentionally switches the operation state of the function due to a misoperation.

2. Input Processing Device

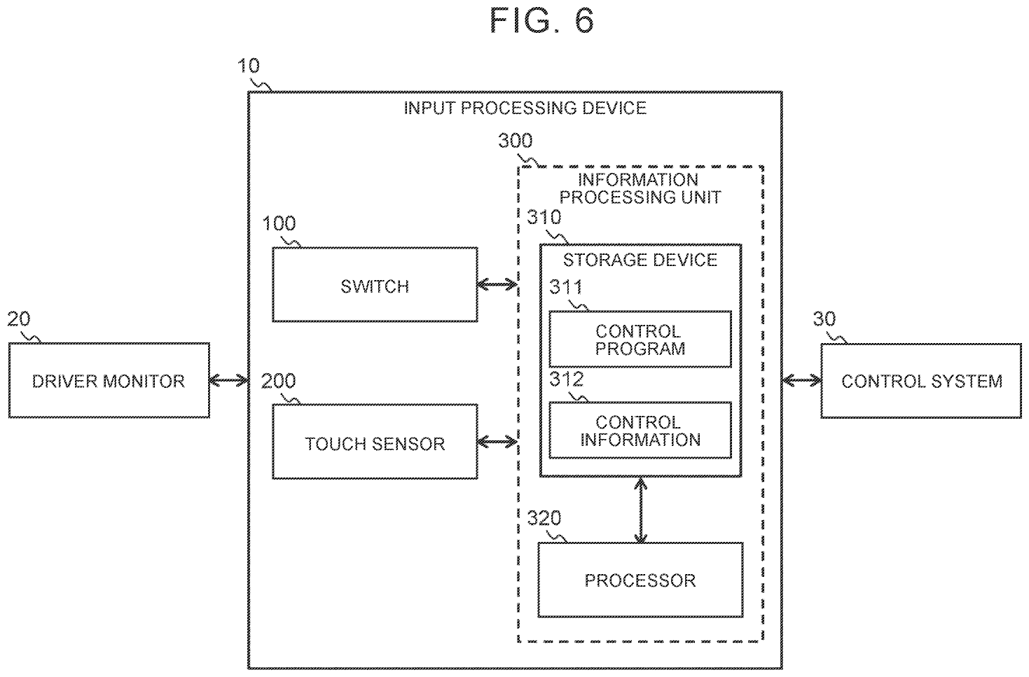

Hereinafter, referring to FIG. 6, the schematic configuration of the input processing device 10 according to the present embodiment is described. The input processing device 10 is configured to mutually transmit/receive information to/from the driver monitor 20 and a control system 30. For example, electrical connection by wire harness, connection by wireless communication, etc., are exemplified.

The driver monitor 20 outputs image information of the image to be taken or information obtained by image recognition of the image to be taken. The information output by the driver monitor 20 is transmitted to the input processing device 10.

The input processing device 10 includes the switch 100, a touch sensor 200, and an information processing unit 300.

The switch 100 receives the operation of the driver 1 and outputs a depression state. The depression state output from the switch 100 is transmitted to the information processing unit 300.

The touch sensor 200 detects whether the finger of the driver 1 is in contact with the pressing surface of the switch 100, and outputs detection information. The touch sensor 200 may be integrally constituted with the switch 100.

The information processing unit 300 is a computer composed of a storage device 310 and a processor 320. The storage device (storage medium) 310 stores a control program 311 executable by the processor 320 and control information 312 necessary for processing executed by the processor 320. A volatile memory, a non-volatile memory, a hard disk drive (HDD), a solid state drive (SSD), etc. are exemplified as the storage device 310. Information acquired by the input processing device 10 is stored in the storage device 310 as the control information 312. Detection information of the driver monitor 20, the depression state of the switch 100, the detection information of the touch sensor 200, parameter information for the control program 311, etc. are exemplified as the control information 312.

The processor 320 reads the control program 311 and the control information 312 from the storage device 310, and executes processes in accordance with the control program 311 based on the control information 312. Thus, the processes related to control of the operation state of the function based on the depression state of the switch 100 is executed, and a control signal for setting the operation state of the function is generated. The processes executed by the processor 320 are described later.

The input processing device 10 outputs a control signal generated by execution of the processes by the processor 320. The control signal output by the input processing device 10 is transmitted to the control system 30.

The control system 30 indicates a system for realizing various functions implemented in the vehicle. An autonomous driving system, a driving support system, etc., are exemplified as the control system 30. The control system 30 operates in accordance with the control signal acquired from the input processing device 10 to realize switching of the operation state of the function based on the depression state of the switch 100. Known suitable configurations may be adopted for the other configurations of the control system 30.

3. Processing

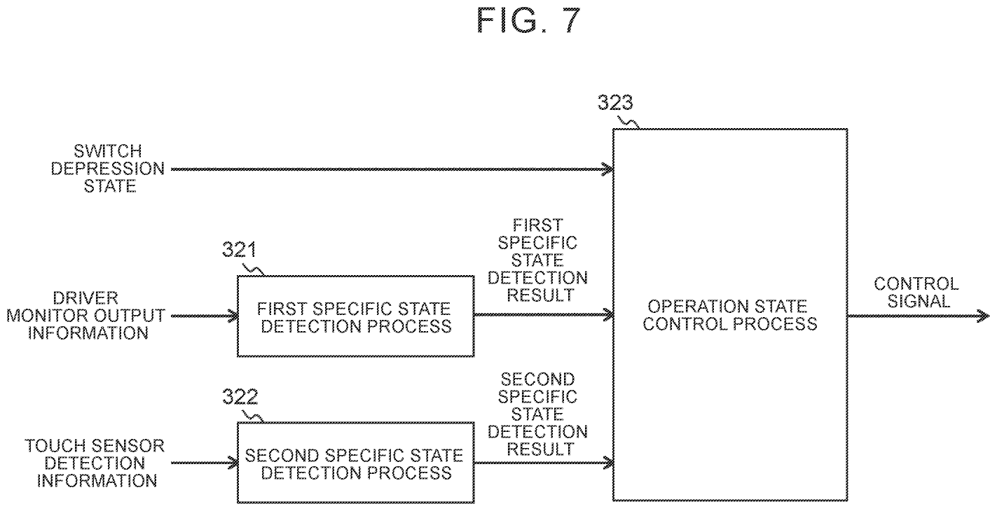

Hereinafter, referring to FIG. 7, the configuration of the processes executed by the processor 320 is described. The processes executed by the processor 320 are composed of a first specific state detection process 321, a second specific state detection process 322, and an operation state control process 323.

In the first specific state detection process 321, the first specific state is detected based on the information output from the driver monitor 20, and the detection result is generated. For example, when the driver monitor 20 outputs the image information of the image to be taken, image recognition processing is executed to detect the first specific state. Alternatively, when the driver monitor 20 outputs information on the direction of the eyes or the face of the driver 1 as information obtained by image recognition, the first specific state is detected from the direction of the eyes or the face of the driver 1.

In the second specific state detection process 322, the second specific state is detected based on the detection information of the touch sensor 200, and the detection result is generated. Here, the configuration may be such that in the second specific state detection process 322, the driver 1 is authenticated, and the second specific state is detected when the finger of the specific driver 1 is in contact with the pressing surface of the switch 100. This can be realized, for example, by the touch sensor 200 having a fingerprint authentication function. With the above configuration, when the finger of a person other than the specific driver 1 is in contact with the pressing surface of the switch 100, detection of the second specific state can be suppressed. Furthermore, switching of the operation state of the function by mischievous operation or the like can be reduced.

In the operation state control process 323, the operation state of a specific function is controlled based on the depression state of the switch 100, and the control signal is generated. Here, in the operation state control process 323, it is determined whether to perform the control of the operation state based on the depression state of the switch 100, based on the detection result by the first specific state detection process 321 and the detection result by the second specific state detection process 322. In the operation state control process 323, the processor 320 is configured to be able to refer to the detection result of the first specific state and the detection result of the second specific state during a predetermined period. For example, the detection result of the first specific state and the detection result of the second specific state during a predetermined period are stored in the storage device 310 as the control information 312.

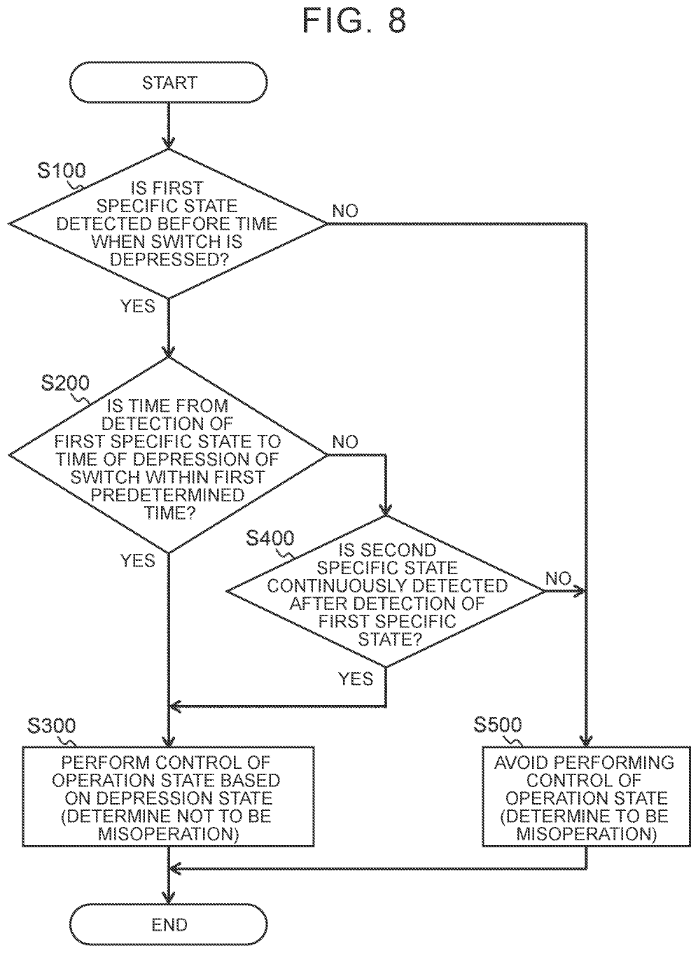

Referring to FIG. 8, the processes executed by the processor 320 in the operation state control process 323 are described. The processes of the flow chart shown in FIG. 8 are started when the switch 100 is depressed.

In step S100, the processor 320 determines whether the first specific state is detected before the time when the switch 100 is depressed. This can be determined from the detection result of the first specific state in a predetermined period stored in the storage device 310.

When the first specific state is detected before the time when the switch 100 is depressed (step S100; Yes), the process proceeds to step S200. When the first specific state is not detected before the time when the switch is depressed (step S100; No), the depression of the switch 100 by the driver 1 is determined to be a misoperation, and the control of the operation state is not performed in this process (step S500).

In step S200, the processor 320 determines whether the time from the detection of the first specific state to the time of depression of the switch is within the first predetermined time. In other words, it is determined whether the first specific state is detected between the time when the switch is depressed and the first predetermined time before the time when the switch is depressed.

When the time from the detection of the first specific state to the time of depression of the switch 100 is within the first predetermined time (step S200; Yes), it is determined that the depression of the switch 100 by the driver 1 is not a misoperation, and the control of the operation state of a specific function based on the depression state of the switch 100 is performed (step S300). When the time from the detection of the first specific state to the time of depression of the switch 100 exceeds the first predetermined time (step S200; No), the process proceeds to step S400.

In step S400, the processor 320 determines whether the second specific state is continuously detected after the detection of the first specific state. In more detail, it is determined whether the first specific state is detected between the time when the second specific state is detected and the second predetermined time before the time when the second specific state is detected, and the second specific state is continuously detected until the time when the switch 100 is depressed.

When the second specific state is continuously detected after the detection of the first specific state (step S400; Yes), it is determined that the depression of the switch 100 by the driver 1 is not a misoperation, and the control of the operation state of a specific function based on the depression state of the switch 100 is performed (step S300). When the second specific state is not continuously detected after the detection of the first specific state (step S400; No), it is determined that the depression of the switch 100 by the driver 1 is a misoperation, and the control of the operation state of is not performed in this process (step S500).

Thus, the processor 320 executes the operation state control process 323. Furthermore, the input processing device 10 according to the present embodiment realizes a function setting method for setting the operation state of a specific function by the switch 100 mounted on the vehicle.

The first predetermined time and the second predetermined time may be the same or may be different. The first predetermined time and the second predetermined time may be suitably provided in accordance with the environment to which the input processing device 10 according to the present embodiment is applied.

4. Effects

As described above, according to the present embodiment, when the switch 100 is depressed, the control of the operation state of a specific function based on the depression state is performed in the case where the first specific state is detected between the time when the switch 100 is depressed and the first predetermined time before the time when the switch 100 is depressed. In this way, it can be determined that the driver 1 reliably recognizes and operates the switch 100 for a specific function. Furthermore, the possibility that the driver 1 unintentionally switches the operation state of a specific function due to a misoperation can be reduced. Furthermore, according to the present embodiment, even when the first specific state is not detected between the time when the switch 100 is depressed and the first predetermined time before the time when the switch 100 is depressed, the control of the operation state of a specific function based on the depression state is performed when the first specific state is detected between the time when the second specific state is detected and the second predetermined time before the time when the second specific state is detected, and the second specific state is continuously detected until the time when the switch 100 is depressed. This makes it possible to address the situation where the driver 1 does not immediately operate the switch 100.

Here, the specific function to be processed may be limited to a driving support function or an autonomous driving function. This can suppress unnecessary processes from being executed for functions less affected by a misoperation of the driver 1. The switch 100 can be limited to a switch mounted on the steering wheel 2 of the vehicle. This can suppress unnecessary processes from being executed for switches having no risk of a misoperation of the driver 1.

What is claimed is:

1. An input processing device configured to execute:
a process for detecting a first specific state indicating that a direction of eyes or a face of a driver of a vehicle is facing a direction of a switch mounted on the vehicle;
a process for acquiring a depression state of the switch; and
a process for controlling, when the switch is depressed, an operation state of a specific function based on the depression state in a case where the first specific state is detected between a time when the switch is depressed and a first predetermined time before the time when the switch is depressed.

2. The input processing device according to claim 1, the input processing device configured to further execute:
a process for detecting a second specific state indicating that a finger of the driver is in contact with a pressing surface of the switch; and
a process for controlling, when the switch is depressed, the operation state of the specific function based on the depression state in a case where the first specific state is detected between a time when the second specific state is detected and a second predetermined time before the time when the second specific state is detected, and the second specific state is continuously detected until the time when the switch is depressed.

3. The input processing device according to claim 1, wherein the specific function is a driving support function or an autonomous driving function of the vehicle.

4. The input processing device according to claim 1, wherein the switch is mounted on a steering wheel of the vehicle.

5. A function setting method for setting an operation state of a specific function by a switch mounted on a vehicle, the function setting method comprising:
detecting a first specific state indicating that a direction of eyes or a face of a driver of the vehicle is facing a direction of the switch mounted on the vehicle;
acquiring a depression state of the switch; and
controlling, when the switch is depressed, the operation state of the specific function based on the depression state in a case where the first specific state is detected between a time when the switch is depressed and a first predetermined time before the time when the switch is depressed.

6. The function setting method according to claim 5, further comprising:
detecting a second specific state indicating that a finger of the driver is in contact with a pressing surface of the switch; and
controlling, when the switch is depressed, the operation state of the specific function based on the depression state in a case where the first specific state is detected between a time when the second specific state is detected and a second predetermined time before the time when the second specific state is detected, and the second specific state is continuously detected until the time when the switch is depressed.

7. A non-transitory storage medium storing a control program executed by a computer and causing the computer to execute the function setting method described in claim 5.
